(19) United States
(12) Patent Application Publication
(10) Pub. No.: US 2007/0036690 A1
(43) Pub. Date: Feb. 15, 2007

(54) Inlet channel volume in a reactor

(75) Inventors: Scott E. Miller, Somerville, MA (US); A. Peter Russo, Woburn, MA (US); Sean J. LeBlanc, Westminister, MA (US); Timothy J. Johnson, Andover, MA (US)

Correspondence Address: WOLF GREENFIELD & SACKS, PC, FEDERAL RESERVE PLAZA, 600 ATLANTIC AVENUE, BOSTON, MA, 02210-2206, US

(73) Assignee: BioProcessors Corp., Woburn, MA (US)

(21) Appl. No.: 11/146,922

(22) Filed: Jun. 7, 2005

Related U.S. Application Data
(60) Provisional application No. 60/609,721, filed on Sep. 14, 2004.
(60) Provisional application No. 60/577,977, filed on Jun. 7, 2004.

(51) Int. Cl. B01J 19/00; B01L 3/00

(52) U.S. Cl. 422/130; 422/129; 422/99

(57) ABSTRACT

The present invention generally relates to chemical, biological, and/or biochemical reactor microreactors and other reaction systems such as microreactor systems, as well as systems and methods for constructing and using such devices. In one aspect, a reactor on a chip has a container in fluid communication with a channel, and the channel is in fluid communication with a port for connecting the container to a source of fluid to be introduced into the container. The container can be very small, for example, with a volume of less than about 2 milliliters, and the fluid channel can have a channel volume of less than 1.5 percent of the container volume. According to another aspect, the combined volume of the port volume and the channel volume can be less than about 10 percent of the container volume. Such a configuration may increase the percentage of added fluid that reaches the container. In fed-batch operations, species may be added and removed via the same channel so that a gas headspace can be maintained within the reactor.

### RELATED APPLICATIONS

This application claims priority under 35 U.S.C. § 119(e) to U.S. Provisional Application Ser. No. 60/577,977, entitled “Gas Control in a Reactor,” filed on Jun. 7, 2004, and U.S. Provisional Application Ser. No. 60/609,721, entitled “Inlet Channel Volume in a Reactor,” filed on Sep. 14, 2004, each of which is herein incorporated in its entirety.

### 1. FIELD OF THE INVENTION

The present invention generally relates to chemical, biological, and/or biochemical reactor chips and/or reaction systems such as microreactor systems.

### 2. DESCRIPTION OF THE RELATED ART

A wide variety of reaction systems are known for the production of products of chemical and/or biochemical reactions. Chemical plants involving catalysis, biochemical fermenters, pharmaceutical production plants, and a host of other systems are well-known. Biochemical processing may involve the use of a live microorganism (e.g., cells) to produce a substance of interest.

Cells are cultured for a variety of reasons. Increasingly, cells are cultured for proteins or other valuable materials they produce. Many cells require specific conditions, such as a controlled environment, for controlled growth or other desired outcome. The presence of nutrients, metabolic gases such as oxygen and/or carbon dioxide, humidity, as well as other factors such as temperature, may affect cell growth. Cells require time to grow, during which favorable conditions must be maintained. In some cases, such as with particular bacterial cells, a successful cell culture may be performed in as little as 24 hours. In other cases, such as with particular mammalian cells, a successful culture may require about 30 days or more.

Typically, cell cultures are performed in media suitable for cell growth and containing necessary nutrients. The cells are generally cultured in a location, such as an incubator, where the environmental conditions can be controlled. Incubators traditionally range in size from small incubators (e.g., about 1 cubic foot) for a few cultures up to an entire room or rooms where the desired environmental conditions can be carefully maintained.

As described in International Patent Application Ser. No. PCT/US01/07679, published on Sep. 20, 2001 as WO 01/68257, entitled “Microreactors,” incorporated herein by reference, cells have also been cultured on a very small scale (i.e., on the order of a few milliliters or less), so that, among other things, many cultures can be performed in parallel. While this and other documents may describe useful microreactor systems, improvements in specific aspects of microreactors would be desirable.

### SUMMARY OF THE INVENTION

Each of the following commonly-owned applications directed to related subject matter and/or disclosing methods and/or devices and/or materials useful or potentially useful for the practice of the present invention is incorporated herein by reference: International Patent Application No. PCT/US03/25956, filed Aug. 19, 2003, entitled “Determination and/or Control of Reactor Environmental Conditions,” by Miller, et al., published as WO 2004/016727 on Feb. 26, 2004; U.S. Patent Application Ser. No. 60/577,985 filed on Jun. 7, 2004, entitled “Control of Reactor Environmental Conditions,” by Rodgers, et al.; an International Patent Application filed on Jun. 7, 2004, entitled “Reactor with Memory Component,” by Zarur, et al.; U.S. Patent Application Ser. No. 60/577,977 filed on Jun. 7, 2004, entitled “Gas Control in a Reactor,” by Rodgers, et al.

The present invention generally relates to chemical, biological, and/or biochemical microreactor systems and chips. The subject matter of this invention involves, in some cases, interrelated products, alternative solutions to a particular problem, and/or a plurality of different uses of one or more systems and/or articles.

In one aspect, the invention is a chemical, biological, or biochemical reactor apparatus. The apparatus, in one set of embodiments, includes a chemical, biological, or biochemical reactor comprising a first reactor comprising a container having a volume of less than about two milliliters. The apparatus also includes a fluid channel in fluid communication with the container, and a port in fluid communication with the fluid channel. A combined volume of the port in the channel is less than about 25 microliters. In some embodiments, the combined volume of the port and the channel is less than about 20 microliters, less than about 15 microliters, or less than about 11 microliters. In some embodiments, the combined volume of the port and the channel is less than about 1% of the container volume or less than about 0.5% of the container volume. In some embodiments, the channel volume is 0.7 microliters or less. In some embodiments, the fluid channel has a channel volume of less than 0.25% of the container volume or less than 0.1% of the container volume.

In some embodiments, the container volume is less than about one milliliter. In some embodiments, the container volume is less than about one milliliter, 500 microliters, 375 microliters, or 100 microliters. In some embodiments, the port has a width that is larger than a width of the fluid channel. In some cases, the port is a self-sealing port. In some embodiments, the source of fluid is a source of at least one of reactants, cell types, and nutrients.

In some cases, the source of fluid is in fluid communication with the fluid channel. In some embodiments, a void space in an interior layer defines the fluid channel, the interior layer being at least partially covered by a first adjacent layer and a second adjacent layer. In some embodiments, the first adjacent layer comprises an elastomeric material. In some embodiments, the port is part of the first adjacent layer. In some embodiments, the container comprises a reaction site having a volume equal to or less than the container volume. In some cases, the reaction site has a volume of less than about 1.3 milliliters or less than 65 microliters. In some embodiments, at least one of the interior layer, the first adjacent layer and the second adjacent layer is injection molded. In some cases, the fluid channel has a largest dimension perpendicular to a direction of flow within a channel of less than about 1 millimeter. In some embodiments, the fluid channel has a largest dimension perpendicular to a direction of flow within the channel of less than about 600 micrometers, about 500 micrometers, or about 200 micrometers.

According to some embodiments, the fluid channel carries nutrients. In some embodiments, a boundary of the container comprises a membrane. According to some embodiments, at least a portion of the reactor comprises 4-methylpentene-1 based polyolefin. In some embodiments, the reactor is able to maintain at least one living cell. In some cases, the apparatus comprises a collection chamber that is connectable to the port. In one embodiment, the collection chamber has a volume of greater than about one liter. In some cases, the reactor is liquid-tight. In some embodiments, the fluid channel is an enclosed channel. In some cases, the container and the fluid channel are etched into a solid support material.

According to some embodiments, the apparatus further comprises a control system able to produce a change in an environmental factor associated with the container. In some embodiments, the control system is integrally connected to the apparatus. In some embodiments, a plurality of reactors are formed on a chip. In some cases, the apparatus comprises a chip having at least a second reactor. In some embodiments, the second reactor is the same as or different from the first reactor. In some embodiments, the second reactor is the same as the first reactor.

The invention is a method for adding a volume of liquid in another aspect. The method, in one set of embodiments, includes providing a chemical, biological, or biochemical reactor chip comprising a first reactor, the first reactor comprising a container having a volume of less than about two milliliters. The method further includes adding a volume of liquid to the container while adding one of no liquid within the first reactor outside of the container and a volume of liquid within the first reactor and outside of the container of no more than 25 microliters. In some embodiments, the volume of liquid added within the first reactor and outside the container is no more than 20 microliters, no more than 15 microliters, or no more than 11 microliters. In some embodiments, the volume of liquid added within the first reactor and outside the container is no more than 1% of the container volume or no more than 0.5% of the container volume. In some cases, providing a chip comprising a first reactor includes providing a chip comprising at least a second reactor. In some cases, the second reactor is the same as or different from the first reactor. In some embodiments, the second reactor is the same as the first reactor.

In accordance with another set of embodiments, an apparatus is defined, at least in part, by a reactor chip including a reactor comprising a container having a volume of less than about 2 milliliters and a predetermined reaction site, the predetermined reaction site having a volume of less than or equal to the container volume. The apparatus further includes a source of at least one of a reactant, a cell type, and a nutrient, the source located outside of the container. The apparatus further includes means for introducing the reactant, cell type or nutrient to the predetermined reaction site, wherein the means for introducing has a volume that is no more than 25 microliters. In some embodiments, the source is located outside of the reactor. In some cases, the means for introducing has a volume that is no more than 1% of the volume of the predetermined reaction site.

In another aspect of the invention, a chemical, biological, or biochemical reactor chip apparatus includes a chemical, biological, or biochemical reactor chip comprising a first reactor comprising container and a port for connecting the container to a source of a fluid to be introduced into the container, wherein the container has a container volume of less than about 2 milliliters, and wherein the port defines a boundary of the container, or a fluid channel connects the port and the container. The fluid channel has channel volume of less than 1% of the container volume. In some embodiments, the channel volume is less than 0.5% of the container volume, less than 0.25% of the container volume, less than 0.19% of the container volume, less than 0.1% of the container volume, or less than 0.05% of the container volume. In some embodiments, the channel volume is 0.7 microliters or less.

In another aspect, a method comprises providing an interior layer, a first adjacent layer adjacent to the interior layer, and a second adjacent layer adjacent to the interior layer, the interior layer having a void that defines a parameter of a container and a void that defines a perimeter of a channel. The method further comprises attaching the first adjacent layer to one side of the interior layer and attaching the second adjacent layer to the opposite side of the interior layer so that a container volume and a channel volume are defined and in fluid communication with one another. The container volume is less than about two milliliters and the channel volume is no more than 1 microliter.

An apparatus, according to another aspect of the invention, comprises at least two predetermined reaction sites, a first predetermined reaction site of the at least two predetermined reaction sites having a volume of less than about two milliliters, and a fluid channel having a volume. The fluid channel is in fluid communication with the first predetermined reaction site, and the volume of the fluid channel is no more than about 0.29 percent of the volume of the first predetermined reaction site.

In another aspect of the invention, a method comprises providing a chip defining a predetermined reaction site with a volume of less than about 2 milliliters, the chip further defining a channel in fluid communication with the predetermined reaction site, the channel having a volume of less than about 0.29 percent of the predetermined reaction site volume. The method further comprises adding a volume of liquid to the predetermined reaction site by passing the liquid through the channel.

Other advantages and novel features of the invention will become apparent from the following detailed description of the various non-limiting embodiments of the invention when considered in conjunction with the accompanying figures. In cases where the present specification and a document incorporated by reference include conflicting and/or inconsistent disclosure, the present specification shall control. If two (or more) applications incorporated by reference include conflicting and/or inconsistent disclosure with respect to each other, then the later-filed application shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For the purposes of clarity, not every component is labeled in every figure, nor is every component of each embodiment of the invention shown where illustration is not necessary to allow those of ordinary skill in the art to understand the invention. In the figures:

FIG. 1 illustrates one embodiment of the invention including six reactors on a layer of a chip;

FIG. 2a illustrates a top view of one embodiment of a container and channel for a reactor system;

FIG. 2b illustrates a cross-sectional side view of the embodiment shown in FIG. 2a;

FIG. 3 illustrates a top exploded view of a device having multiple layers according to one embodiment of the invention; and

FIG. 4 is a block diagram of an example of a control system according to one embodiment of the invention.

### DETAILED DESCRIPTION

The present invention generally relates to chemical, biological, and/or biochemical reactor chips and other reaction systems such as microreactor systems, as well as systems and methods for constructing and using such devices. The invention involves, in one aspect, adding nutrients or other reaction components to a container through a channel (serving as an inlet) and then withdrawing at least one reaction product or other species from the container through the same channel, a process referred to herein as a “fed-batch” operation. When providing components to the container through a port and/or channel that is in fluid communication with the container, a certain amount of fluid remains in the port and/or channel after the addition is complete. In many cases it can be desirable to limit the amount of nutrients that remain in this “dead-space,” especially where a reaction system may include containers that can be very small, for example, containers having volumes of less than about 2 milliliters. Accordingly, in another aspect of the invention, a chip or other reaction system may be configured so as to limit the volume of fluid present in a channel that feeds a reactor container.

According to one aspect of the invention, a channel and/or port may be configured to increase the percentage of added liquid that reaches a container. For example, the port may be located at or near the container so that a small (or even zero) amount of added fluid resides within the port and/or channel and/or other component of the chip (or other reactor system) without reaching the container.

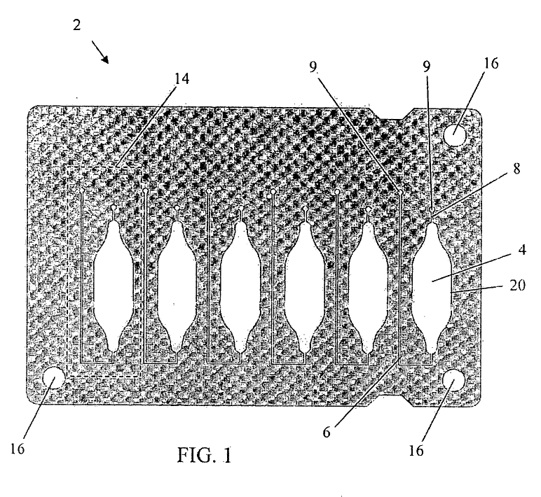

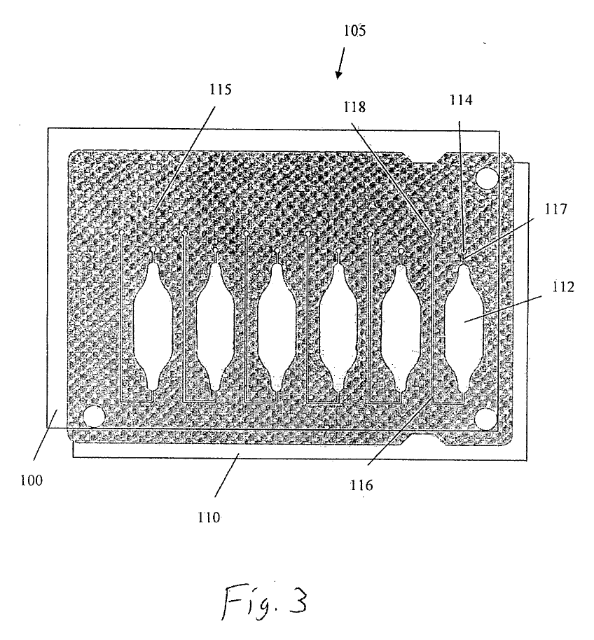

Referring now to FIG. 1, one portion of a chip according to one embodiment is illustrated schematically. The portion illustrated is a layer 2 which includes within it a series of void spaces which, when layer 2 is positioned between two adjacent layers (not shown in FIG. 1), define a series of enclosed channels and reaction sites. The overall arrangement into which layer 2 can be assembled to form a chip will be understood more clearly from the description below with respect to FIG. 3.

FIG. 1 represents an embodiment including six reaction sites 4 (analogous to, for example, reaction site 112 of FIG. 3, described below). Reaction sites 4 define a series of generally aligned, elongated voids within a relatively thin, generally planar piece of material defining layer 2. In the embodiment of FIG. 1, reaction sites 4 are containers 20. Reaction sites 4 can be addressed by a series of channels including channels 8 for delivering species to reaction sites 4 and for removing species from the reaction sites. In fed-batch operations, species may be added and removed via the same channel 8 so that a gas headspace can be maintained within reactor 14. Of course, any combination of channels can be used to deliver and/or remove species from the reaction sites. For example, channels 8 can be used to deliver species to the reaction sites while channels 6 can be used to remove species, or vice versa. Channels 6 and 8 define voids within layer 2 which, when covered above and/or below by other layers, may become enclosed channels. Each of channels 6 and 8, in the embodiment illustrated in FIG. 1, is addressed by a port 9.

Where port 9 is fluidly connected to a short channel it can define a liquid port, and where fluidly connected to a long channel it can define a gas port. In the embodiment illustrated, port 9 is a void that is larger in width than the width of channels 6 or 8. Those of ordinary skill in the art will recognize a variety of techniques for accessing ports 9 and using them to introduce species into channels, and/or remove species from channels addressed by those ports. As one example, port 9 can be a “self-sealing” port, addressable by a needle (as described more fully below) when at least one side of port 9 is covered by a layer (not shown) of material which, when a needle is inserted through the material and withdrawn, forms a seal generally impermeable to species such as fluids introduced into or removed from the chip via the port. As used herein, a port may include an inlet and/or outlet that permits selective opening and closing for introducing species/fluids to or removing species from a container. A port also may include a junction of more than one channel that allows for the selective introduction and/or removal of various fluids or species. A port may be directly adjacent a container such that the port forms a boundary of the container, or, in other embodiments, a port may be connected to a container via a channel.

In FIG. 1, each reaction site 4, along with the associated fluidic connections (e.g., channels 6 and 8, and ports 9), together define a reactor 14, as indicated by dashed lines. In FIG. 1, layer 2 contains six such reactors, each reactor having substantially the same configuration. In other embodiments, a reactor may include more than one reaction site, and channels, ports, etc. Additionally, a chip layer may have reactors that do not have substantially the same configuration as one another.

Additionally shown in FIG. 1 is a series of devices 16 which can be used to secure layer 2 to other layers of a chip and/or to assure alignment of layer 2 with other layers and/or other systems to which the chip is desirably coupled. Devices 16 can define screws, posts, indentations (i.e., that match corresponding protrusions of other layers or devices), or the like. Those of ordinary skill in the art are aware of a variety of suitable techniques for securing layers to other layers and/or chips of the invention to other components or systems using devices such as these.

A variety of definitions are now provided which will aid in understanding of the invention. Following, and interspersed with these definitions, is further disclosure, including descriptions of figures, that will fully describe various embodiments of the invention. It is to be understood that in FIG. 1, and in all of the other figures, the arrangement of reaction sites, number of reaction sites, arrangement of channels addressing reaction sites, ports, and the like are merely given as examples that fall within the overall invention.

As used herein, a “reactor” is the combination of components including a reaction site, any containers (including reaction containers and ancillary containers), channels, ports, inlets and/or outlets (i.e., leading to or from a reaction site), sensors, actuators, processors, controllers, membranes, and the like, which, together, operate to promote and/or monitor a biological, chemical, or biochemical reaction, interaction, operation, or experiment at a reaction site, and which can be part of a chip. Of course, a reactor need not include all of the above-listed components to be considered a reactor. For example, a chip may include at least 2, at least 5, at least 6, at least 10, at least 20, at least 50, at least 100, at least 500, or at least 1,000 or more reactors. Examples of reactors include chemical or biological reactors and cell culturing devices, as well as the reactors described in International Patent Application Ser. No. PCT/US01/07679, published on Sep. 20, 2001 as WO 01/68257, incorporated herein by reference. Reactors can include one or more reaction sites or containers.

The reactor may be used for any chemical, biochemical, and/or biological purpose, for example, cell growth, pharmaceutical production, chemical synthesis, hazardous chemical production, drug screening, materials screening, drug development, chemical remediation of warfare reagents, or the like. For example, the reactor may be used to facilitate very small scale culture of cells or tissues. In one set of embodiments, a reactor of the invention comprises a matrix or substrate of a few millimeters to centimeters in size, containing channels with dimensions on the order of, e.g., tens or hundreds of micrometers. Reagents of interest may be allowed to flow through these channels, for example to a reaction site, or between different reaction sites, and the reagents may be mixed or reacted in some fashion. The products of such reactions can be recovered, separated, and treated within the system in certain cases.

As used herein, a “channel” is a conduit associated with a reactor and/or a chip (within, leading to, or leading from a reaction site) that is able to transport one or more fluids specifically from one location to another, for example, from an inlet of the reactor or chip to a reaction site, e.g., as further described below. Materials (e.g., fluids, cells, particles, etc.) may flow through the channels, continuously, randomly, intermittently, etc. The channel may be a closed channel, or a channel that is open, for example, open to the external environment surrounding the reactor or chip containing the reactor. The channel can include characteristics that facilitate control over fluid transport, e.g., structural characteristics (e.g., an elongated indentation), physical/chemical characteristics (e.g., hydrophobicity vs. hydrophilicity) and/or other characteristics that can exert a force (e.g., a containing force) on a fluid when within the channel. The fluid within the channel may partially or completely fill the channel. In some cases the fluid may be held or confined within the channel or a portion of the channel in some fashion, for example, using surface tension (i.e., such that the fluid is held within the channel within a meniscus, such as a concave or convex meniscus). The channel may have any suitable cross-sectional shape that allows for fluid transport, for example, a square channel, a circular channel, a rounded channel, a rectangular channel (e.g., having any aspect ratio), a triangular channel, an irregular channel, etc. The channel may have a largest dimension perpendicular to a direction of fluid flow within the channel of less than about 1000 micrometers in some cases, less than about 600 micrometers in other cases, less than about 500 micrometers in other cases, less than about 400 micrometers in other cases, less than about 300 micrometers in other cases, less than about 200 micrometers in still other cases, less than about 100 micrometers in still other cases, or less than about 50 or 25 micrometers in still other cases. In embodiments of the invention, the channel dimensions may be chosen to limit the volume of fluid that remains in the channel after fluid has been introduced to the container and/or reaction site through the channel. For example, in some embodiments, the channel may have a volume of five microliters or less, two microliters or less, one microliter or less, or 0.7 microliters or less. In some embodiments, the channel may have a volume that is less than 1.5 percent of the container volume, less than 0.5 percent of the container volume, less than 0.25 percent of the container volume, less than 0.19 percent of the container volume, less than 0.1 percent of the container volume, or less than 0.05 percent of the container volume. In some embodiments, the channel may have a volume that is no more than 2.25 percent of the volume of the reaction site, no more than 0.75 percent of the reaction site, no more than 0.375 percent of the reaction site, no more than 0.29 percent of the reaction site, or no more than 0.075 percent of the reaction site. In some embodiments, the dimensions of the channel may be chosen such that fluid is able to freely flow through the channel, for example, if the fluid contains cells. The dimensions of the channel may also be chosen in certain cases, for example, to allow a certain volumetric or linear flowrate of fluid within the channel. In one embodiment, the depth or other largest dimension perpendicular to a direction of fluid flow may be similar to that of a reaction site with which the channel is in fluid communication. Of course, the number of channels, the shape or geometry of the channels, and the placement of channels within the chip can be determined by those of ordinary skill in the art.

As used herein, a “reaction site” is defined as a site within a reactor that is constructed and arranged to produce a physical, chemical, biochemical, and/or biological reaction during use of the reactor. More than one reaction site may be present within a reactor or a chip in some cases. The reaction site may be defined as a region where a reaction is allowed to occur; for example, the reactor may be constructed and arranged to cause a reaction within a channel, one or more containers, at the intersection of two or more channels, etc. The reaction may be, for example, a mixing or a separation process, a reaction between two or more chemicals, a light-activated or a light-inhibited reaction, a biological process, and the like. In some embodiments, the reaction may involve an interaction with light that does not lead to a chemical change, for example, a photon of light may be absorbed by a substance associated with the reaction site and converted into heat energy or re-emitted as fluorescence. In certain embodiments, the reaction site may also include one or more cells and/or tissues. Thus, in some cases, the reaction site may be defined as a region surrounding a location where cells are to be placed within the reactor, for example, a cytophilic region within the reactor.

The volume of the reaction site can be very small in certain embodiments and may have any convenient size. Specifically, the reaction site may have a volume of less than about 2 ml, less than about 1 ml, less than about 500 microliters, less than about 375 microliters, less than about 300 microliters, less than about 200 microliters, less than about 100 microliters, less than about 50 microliters, less than about 30 microliters, less than about 20 microliters or less than about 10 microliters in various embodiments. The reaction site may also have a volume of less than about 5 microliters, or less than about 1 microliter in certain cases. The volume of the container also can be very small in certain embodiments and may have any convenient size. Specifically, the container may have a volume similar to the volumes listed above for the reaction site (e.g., less than about 375 microliters). In some embodiments, the reaction site is a subset of the container, and in other embodiments, the reaction site is the same volume as the container.

A “chemical, biological, or biochemical reactor chip,” (also referred to, equivalently, simply as a “chip”) as used herein, is an integral article that includes one or more reactors. “Integral article” means a single piece of material, or assembly of components integrally connected with each other. As used herein, the term “integrally connected,” when referring to two or more objects, means objects that do not become separated from each other during the course of normal use, e.g., cannot be separated manually; separation requires at least the use of tools, and/or by causing damage to at least one of the components, for example, by breaking, peeling, etc. (separating components fastened together via adhesives, tools, etc.).

A chip can be connected to or inserted into a larger framework defining an overall reaction system, for example, a high-throughput system. The system can be defined primarily by other chips, chassis, cartridges, cassettes, and/or by a larger machine or set of conduits or channels, sources of reactants, cell types, and/or nutrients, inlets, outlets, sensors, actuators, and/or controllers. Typically, the chip can be a generally flat or planar article (i.e., having one dimension that is relatively small compared to the other dimensions); however, in some cases, the chip can be a non-planar article, for example, the chip may have a cubical shape, a curved surface, a solid or block shape, etc.

In some cases, the reactor may include a region containing a gas (e.g., a “gas head space”), for example, if the reaction site is not completely filled with a liquid. The presence of a gas head space permits the addition of liquid to the reactor without forcing liquid out of a different port. When liquid is added to the reactor that has a gas head space in fluid communication with a port, gas is forced out of the reactor rather than liquid.

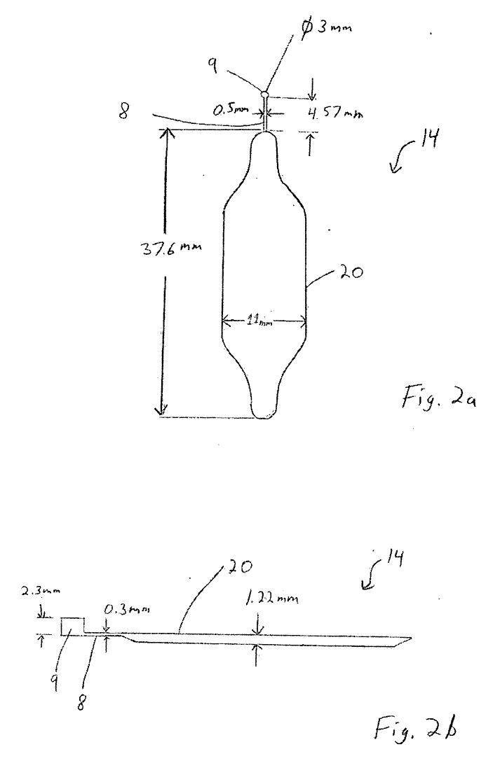

The following description of reactor 14 illustrated in FIGS. 2a and 2b is for one embodiment. It should be understood that numerous other constructions of further embodiments fall within the scope of the invention. Container 20 is about 11 mm in width at its maximum width, approximately 37.6 mm in length, and about 1.22 mm in height having a total volume of approximately 375 microliters. Container 20 is fluidly connected to channel 8. Channel 8 is approximately 0.5 mm wide, approximately 4.57 mm long, approximately 0.3 mm deep, and may serve as a fluid channel such as a liquid inlet and/or outlet channel. According to one embodiment, the microchannel and the cell growth container are etched into a solid support material.

Port 9 for channel 8 is cylindrical and has a diameter of approximately 3 mm and a depth of approximately 2.3 mm, with a volume of approximately 16 milliliters. In some embodiments, port 9 is constructed and arranged to receive a needle. In some embodiments, port 9 may have a different shape and different dimensions. For example, port 9 may have a diameter that is similar to the width of channel 8.

Container 20 has a certain shape in the illustrated embodiment, but container 20 may be of any suitable shape. For example, container 20 may have a rectangular shape with rounded corners.

FIG. 3 illustrates one configuration of an assembly of one embodiment of the invention. FIG. 3 illustrates a top exploded view of a chip 105. In this embodiment, chip 105 is composed of three layers of material, namely, upper layer 100 (which is transparent in the embodiment illustrated), interior layer 115, and lower layer 110. Of course, in other embodiments of the invention, chip 105 may have more or fewer layers of material (e.g., including only one layer), depending on the specific application. In the embodiment shown in FIG. 5, interior layer 115 has one or more void spaces 112, defining a plurality of predetermined reaction sites. One or more channels 116, 117 may also be defined within interior layer 115, and be in fluid communication with void space 112. In some cases, one or more ports 114, 118 may allow external access to the channels, for example through upper layer 100.

As used herein, “upper,” “lower,” and other descriptors that imply a particular orientation of any device of the invention are illustrative only. For example, an “upper” component of a device is used merely to illustrate a position of that component relative to another component and, while the “upper” component may actually be above other components during use of the device, the device can be oriented in different ways such that the “upper” component is beside, below, or otherwise differently oriented relative to a “lower” component.

Upper layer 100 may be adjacent to and/or may cover or at least partially cover interior layer 115, thereby in part defining reaction site(s). In some cases, upper layer 100 may be permeable to a gas or liquid, for example, in cases where a gas or liquid agent is allowed to permeate or penetrate through upper layer 100. For instance, upper layer 100 may be formed of a polymer such as PDMS or silicone, which may be thin enough to allow detectable or measurable gaseous transport therethrough. In certain instances, upper layer 100 may be formed of a material that is self-sealing, i.e., the material may be penetrated by a solid object but generally regains its shape after such penetration. For example, upper layer 100 may be formed of an elastomeric material which may be penetrated by a mechanical device such as a needle, but which sealingly closes once the needle or other mechanical device is withdrawn.

Interior layer 115 includes six void spaces that define containers in the embodiment illustrated in FIG. 3. Of course, in other embodiments, more or fewer void spaces may be present within interior layer 115. In the embodiment illustrated in FIG. 3, a void space in interior layer 115, along with upper layer 100 and lower layer 110, may define a reaction site. In the embodiment of FIG. 3, there are six reaction sites, which are substantially identical; however, in other embodiments of the invention, more or fewer predetermined reaction sites may exist, and the reaction sites may each be the same or different. In the embodiment shown, each void space is substantially identical and has two fluid channels 116, 117 in communication with the void space. Of course, in other embodiments of the invention, there may be more or fewer channels running throughout the chip. In the embodiment of FIG. 3, fluid channel 116 is connected to port 118 in layer 115, and fluid channel 117 is connected to port 114 in layer 115; in other embodiments, of course, fluid channels 116 and 117 may fluidly connect one or more reaction sites to each other, to one or more fluid ports, and/or to one or more other components within chip 105. Ports 114 and/or 118 may be used to introduce or withdraw fluids or other substances from the reactor in some cases. In some embodiments of the invention, reaction sites and/or one or more fluidic channels may be defined, for example, in one or more layers of the chip, for example, solely within one layer, at a junction between two layers, in a void space that spans three layers, etc.

Ports 114 and 118 may be in fluid communication with one or more reaction site(s). Ports 114 and 118 may be accessible, in some cases, by inserting a needle or other mechanical device through upper layer 100. For example, in some cases, upper layer 100 may be penetrated, or a space in upper layer 100 may permit external access to ports 114 and/or 118. In some cases, upper layer 100 may be composed of a flexible or elastomeric material, which may be self-sealing in some cases. In certain instances, upper layer 100 may have a passage formed therein that allows direct or indirect access to ports 114 and/or 118, or ports 114 and/or 118 may be formed in upper layer 100 and connected to channels 116 and 117 through channels defined within layer 100.

Lower layer 110 forms the bottom of chip 105, as illustrated in FIG. 3. As previously described, parts of lower layer 110 in part may define a reaction site in certain instances. In some cases, lower layer 110 may be formed of a relatively hard or rigid material, which may give relatively rigid structural support to chip 105. Of course, in other embodiments, lower layer 110 may be formed of a flexible or elastomeric material (i.e., non-rigid). In some cases, lower layer 110 may contain one or more channels defined therein and/or one or more ports defined therein. In some cases, material defining a boundary of the reaction site, such as lower layer 110 (or upper layer 100), may contain salts and/or other materials, for example, in cases where the materials are reacted in some fashion to produce an agent that is allowed to be transported to or proximate reaction site 112. The agent may be any agent as previously discussed, for instance, a gas, a liquid, an acid, a base, a tracer compound, a small molecule (e.g., a molecule with a molecular weight of less than about 1000 Da-1500 Da), a drug, a protein, or the like, and transport may occur by any suitable mechanism, for example, diffusion (natural or facilitated) or percolation.

It should be understood that the chips and reactors of the present invention may have a wide variety of different configurations. For example, the chip may be formed from a single material, or the chip may contain more than one type of reactor, reservoir and/or agent.

Many embodiments and arrangements of the invention are described with reference to a chip, or to a reactor, and those of ordinary skill in the art will recognize that the invention can apply to either or both. For example, a channel arrangement may be described in the context of one, but it will be recognized that the arrangement can apply in the context of the other (or, typically, both: a reactor which is part of a chip). It is to be understood that all descriptions herein that are given in the context of a reactor or chip apply to the other, unless inconsistent with the description of the arrangement in the context of the definitions of “chip” and “reactor” herein.

In some cases, cells can be present at the reaction site. Sensor(s) associated with the chip or reactor, in certain cases, may be able to determine the number of cells, the density of cells, the status or health of the cells, the cell type, the physiology of the cells, etc. In certain cases, the reactor can also maintain or control one or more environmental factors associated with the reaction site, for example, in such a way as to support a chemical reaction or a living cell.

As used herein, a “control system” is a system able to detect and/or measure one or more environmental factors within or associated with the reaction site, and cause a response or a change in the environmental conditions within or associated with the reaction site (for instance, to maintain an environmental condition at a certain value). In some cases, the control system may control the environmental factor in real time. The response produced by the control system may be based on the environmental factor in certain cases.

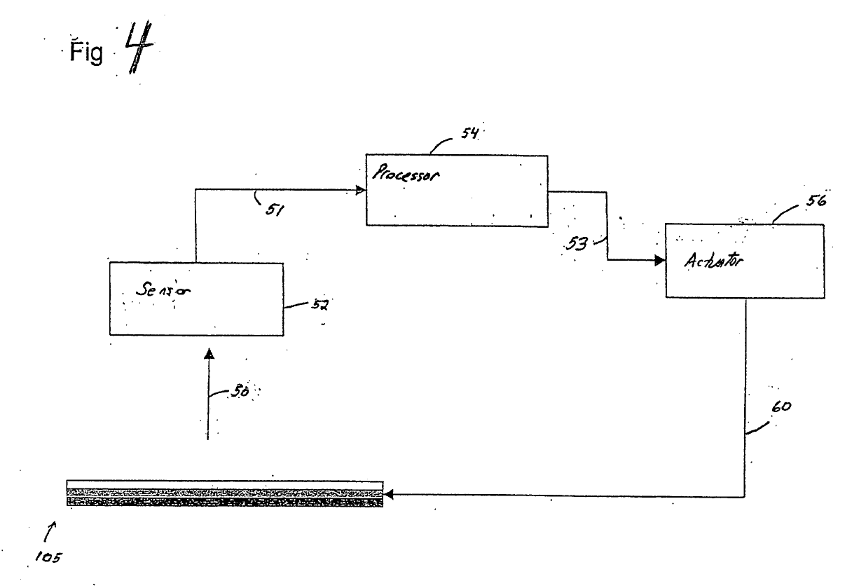

The control system can include a number of control elements, for example, a sensor operatively connected to an actuator, and optionally to a processor. One or more of the components of the control system may be integrally connected to the chip containing the reaction site, or separate from the chip. In some cases, the control system includes components that are integral to the chip and other components that are separate from the chip. The components may be within or proximate to the reaction site (e.g., upstream or downstream of the reaction site, etc.). Of course, in some embodiments, the control system may include more than one sensor, processor, and/or actuator, depending on the application and the environmental factor(s) to be detected, measured, and/or controlled. One example of a control system is depicted in FIG. 4, in which an environmental condition 50 within chip 105, detected by a sensor 52, is transduced into a signal 51 that is transmitted to processor 54 for suitable processing. Processor 54 then produces a signal 53, which is sent to actuator 56 where the signal is converted into a response 60. In some embodiments, the control system may be able to produce a very rapid change in the environmental factor in response to a stimulus or a change in stimulus (for example, a detectable change in an environmental factor such as temperature or pH in a time of less than 5 s, less than 1 s, less than 100 ms, less than 10 ms, or less than 1 ms).

The inlets and/or outlets of the chip, directed to one or more reactors, containers and/or reaction sites may include inlets and/or outlets for a fluid such as a gas or a liquid, for example, for a waste stream, a reactant stream, a product stream, an inert stream, etc. In some cases, the chip may be constructed and arranged such that fluids entering or leaving reactors and/or reaction sites do not substantially disturb reactions that may be occurring therein. For example, fluids may enter and/or leave a reaction site without affecting the rate of reaction in a chemical, biochemical, and/or biological reaction occurring within the reaction site, or without disturbing and/or disrupting cells that may be present within the reaction site. Examples of inlet and/or outlet gases may include, but are not limited to, CO₂, CO, oxygen, hydrogen, NO, NO₂, water vapor, nitrogen, ammonia, acetic acid, etc. As another example, an inlet and/or outlet fluid may include liquids and/or other substances contained therein, for example, water, saline, cells, cell culture medium, blood or other bodily fluids, antibodies, pH buffers, solvents, hormones, carbohydrates, nutrients, growth factors, therapeutic agents (or suspected therapeutic agents), antifoaming agents (e.g., to prevent production of foam and bubbles), proteins, antibodies, and the like. The inlet and/or outlet fluid may also include a metabolite in some cases. A “metabolite,” as used herein, is any molecule that can be metabolized by a cell. For example, a metabolite may be or include an energy source such as a carbohydrate or a sugar, for example, glucose, fructose, galactose, starch, corn syrup, and the like. Other example metabolites include hormones, enzymes, proteins, signaling peptides, amino acids, etc.

The inlets and/or outlets may be formed within the chip by any suitable technique known to those of ordinary skill in the art, for example, by holes or apertures that are punched, drilled, molded, milled, etc. within the chip or within a portion of the chip, such as a substrate layer. In some cases, the inlets and/or outlets may be lined, for example, with an elastomeric material. In certain embodiments, the inlets and/or outlets may be constructed using self-sealing materials that may be re-usable in some cases. For example, an inlet and/or outlet may be constructed out of a material that allows the inlet and/or outlet to be liquid-tight (i.e., the inlet and/or outlet will not allow a liquid to pass therethrough without the application of an external driving force, but may admit the insertion of a needle or other mechanical device able to penetrate the material under certain conditions). In some cases, upon removal of the needle or other mechanical device, the material may be able to regain its liquid-tight properties (i.e., a “self-sealing” material). Non-limiting examples of self-sealing materials suitable for use with the invention include, for example, polymers such as polydimethylsiloxane (“PDMS”), natural rubber, HDPE, or silicone materials such as Formulations RTV 108, RTV 615, or RTV 118 (General Electric, New York, N.Y.).

As used herein, a “membrane” is a thin sheet of material, typically having a shape such that one of the dimensions is substantially smaller than the other dimensions, that is permeable to at least one substance in an environment to which it is or can be exposed, e.g., a semi-permeable membrane. In some cases, the membrane may be generally flexible or non-rigid. Non-limiting examples of substances to which the membrane may be permeable to include water, O₂, CO₂, or the like. As an example, a membrane may have a permeability to water of less than about 1000 (g micrometer/m² day), 900 (g micrometer/m² day), 800 (g micrometer/m² day), 600 (g micrometer/m² day) or less; the actual permeability of water through the membrane may also be a function of the relative humidity in some cases.

In some embodiments, the chip of the present invention may include very small elements, for example, sub-millimeter or microfluidic elements. For example, in some embodiments, the chip may include at least one reaction site or container having a cross sectional dimension of no greater than, for example, 100 mm, 80 mm, 50 mm, or 10 mm. In some embodiments, the reaction site may have a maximum cross section no greater than, for example, 100 mm, 80 mm, 50 mm, or 10 mm. As used herein, the “cross section” refers to a distance measured between two opposed boundaries of the reaction site, and the “maximum cross section” refers to the largest distance between two opposed boundaries that may be measured. In other embodiments, a cross section or a maximum cross section of a reaction site may be less than 5 mm, less than 2 mm, less than 1 mm, less than 500 micrometers, less than 300 micrometers, less than 100 micrometers, less than 10 micrometers, or less than 1 micrometer or smaller. As used herein, a “microfluidic chip” is a chip comprising at least one fluidic element having a sub-millimeter cross section, i.e., having a cross section that is less than 1 mm. As one particular non-limiting example, a reaction site may have a generally rectangular shape, with a length of 80 mm, a width of 10 mm, and a depth of 5 mm.

While one reaction site may be able to hold and/or react a small volume of fluid as described herein, the technology associated with the invention also allows for scalability and parallelization. With regard to throughput, an array of many reactors and/or reaction sites within a chip, or within a plurality of chips, can be built in parallel to generate larger capacities. For example, a plurality of chips (e.g. at least about 10 chips, at least about 30 chips, at least about 50 chips, at least about 75 chips, at least about 100 chips, at least about 200 chips, at least about 300 chips, at least about 500 chips, at least about 750 chips, or at least about 1,000 chips or more) may be operated in parallel, for example, through the use of robotics, for example which can monitor or control the chips automatically.

Chips of the invention can be substantially liquid-tight in one set of embodiments. As used herein, a “substantially liquid-tight chip” or a “substantially liquid-tight reactor” is a chip or reactor, respectively, that is constructed and arranged, such that, when the chip or reactor is filled with a liquid such as water, the liquid is able to enter or leave the chip or reactor solely through defined inlets and/or outlets of the chip or reactor, regardless of the orientation of the chip or reactor, when the chip is assembled for use. In this set of embodiments, the chip is constructed and arranged such that when the chip or reactor is filled with water and the inlets and/or outlets sealed, the chip or reactor has an evaporation rate of less than about 100 microliters per day, less than about 50 microliters per day, or less than about 20 microliters per day. In certain cases, a chip or reactor will exhibit an unmeasurable, non-zero amount of evaporation of water per day. The substantially liquid-tight chip or reactor can have a zero evaporation rate of water in other cases.

Chips of the invention can be fabricated using any suitable manufacturing technique for producing a chip having one or more reactors, each having one or multiple reaction sites, and the chip can be constructed out of any material or combination of materials able to support a fluidic network necessary to supply and define at least one reaction site. Non-limiting examples of microfabrication processes include wet etching, chemical vapor deposition, deep reactive ion etching, anodic bonding, injection molding, hot pressing, and LIGA. For example, the chip may be fabricated by etching or molding silicon or other substrates, for example, via standard lithographic techniques. The chip may also be fabricated using microassembly or micromachining methods, for example, stereolithography, laser chemical three-dimensional writing methods, modular assembly methods, replica molding techniques, injection molding techniques, milling techniques, and the like as are known by those of ordinary skill in the art. The chip may also be fabricated by patterning multiple layers on a substrate (which may be the same or different), for example, as further described below, or by using various known rapid prototyping or masking techniques. Examples of materials that can be used to form chips include polymers, silicones, glasses, metals, ceramics, inorganic materials, and/or a combination of these. The materials may be opaque, semi-opaque translucent, or transparent, and may be gas permeable, semi-permeable or gas impermeable.

In some embodiments, a chip of the invention may be formed from or include a polymer, such as, but not limited to, polyacrylate, polymethacrylate, polycarbonate, polystyrene, polyethylene, polypropylene, polyvinylchloride, polytetrafluoroethylene, a fluorinated polymer, a silicone such as polydimethylsiloxane, polyvinylidene chloride, bis-benzocyclobutene (“BCB”), a polyimide, a fluorinated derivative of a polyimide, or the like. In one set of embodiments, the chip or other support material includes a polymer which may include a poly(acetylene) and/or a poly(alkylacetylene).

In some embodiments of the invention, a reactor and/or a reaction site within a chip may be constructed and arranged to maintain an environment that promotes the growth of one or more types of living cells, for example, simultaneously. In some cases, the reaction site may be provided with fluid flow, oxygen, nutrient distribution, etc., conditions that are similar to those found in living tissue, for example, tissue that the cells originate from. Thus, the chip may be able to provide conditions that are closer to in vivo than those provided by batch culture systems. In embodiments where one or more cells are used in the reaction site, the cells may be any cell or cell type, for instance a prokaryotic cell or a eukaryotic cell. The precise environmental conditions necessary in the reaction site for a specific cell type or types may be determined by those of ordinary skill in the art.

In some cases, the invention may be used in high throughput screening techniques. For example, the invention may be used to assess the effect of one or more selected compounds on cell growth, normal or abnormal biological finction of a cell or cell type, expression of a protein or other agent produced by the cell, or the like. The invention may also be used to investigate the effects of various environmental factors on cell growth, cell biological function, production of a cell product, etc.

In certain cases, a reactor and/or a reaction site within a chip may be constructed and arranged to prevent, facilitate, and/or determine a chemical or a biochemical reaction with the living cells within the reaction site (for example, to determine the effect, if any, of an agent such as a drug, a hormone, a vitamin, an antibiotic, an enzyme, an antibody, a protein, a carbohydrate, etc. on a living cell). For example, one or more agents suspected of being able to interact with a cell may be added to a reactor and/or a reaction site containing the cell, and the response of the cell to the agent(s) may be determined, using the systems and methods of the invention.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B”, when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of”, when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one act, the order of the acts of the method is not necessarily limited to the order in which the acts of the method are recited.

In the claims, as well as in the specification above, all transitional phrases such as “comprising,” “including,” “carrying,” “having,” “containing,” “involving,” “holding, ” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A chemical, biological, or biochemical reactor apparatus, comprising:
a chemical, biological, or biochemical reactor comprising a container having a volume of less than about 2 milliliters;
a fluid channel in fluid communication with the container; and
a port in fluid communication with the fluid channel; wherein
a combined volume of the port and the channel is less than about 25 microliters.

2. An apparatus as in claim 1, wherein the combined volume of the port and the channel is less than about 20 microliters.

3. An apparatus as in claim 1, wherein the combined volume of the port and the channel is less than about 15 microliters.

4. An apparatus as in claim 1, wherein the combined volume of the port and the channel is less than about 11 microliters.

5. An apparatus as in claim 1, wherein the combined volume of the port and the channel is less than about 1 percent of the container volume.

6. An apparatus as in claim 1, wherein the combined volume of the port and the channel is less than about 0.5 percent of the container volume.

7. An apparatus as in claim 1, wherein the fluid channel has a channel volume of 0.7 microliters or less.

8. An apparatus as in claim 1, wherein the fluid channel has a channel volume of less than 0.25 percent of the container volume.

9. An apparatus as in claim 1, wherein the fluid channel has a channel volume of less than 0.1 percent of the container volume.

10. An apparatus as in claim 1, wherein the container volume is less than about 1 milliliter.

11. An apparatus as in claim 1, wherein the container volume is less than about 500 microliters.

12. An apparatus as in claim 1, wherein the container volume is less than about 375 microliters.

13. An apparatus as in claim 1, wherein the container volume is less than about 100 microliters.

14. An apparatus as in claim 1, wherein the port has a width that is larger than a width of the fluid channel.

15. An apparatus as in claim 1, wherein the port is a self-sealing port.

16. An apparatus as in claim 1, further comprising a source of a fluid to be introduced into the container, wherein the source of fluid is a source of at least one of reactants, cell types, and nutrients.

17. An apparatus as in claim 1, wherein the source of fluid is in fluid communication with the fluid channel.

18-40. (canceled)

41. A method for adding a volume of liquid, comprising:
providing a chemical, biological, or biochemical reactor chip comprising a first reactor, the first reactor comprising a container having a container volume of less than about 2 milliliters; and
adding a volume of liquid to the container while adding one of:
no liquid within the first reactor outside of the container; and
a volume of liquid within the first reactor and outside of the container, the volume of liquid added within the first reactor and outside the container being no more than 25 microliters.

42-49. (canceled)

50. A chemical, biological, or biochemical reactor chip apparatus comprising:
a chemical, biological, or biochemical reactor chip comprising a reactor comprising a container having a volume of less than about 2 milliliters and a predetermined reaction site, the predetermined reaction site having a volume less than or equal to the container volume;
a source of at least one of a reactant, a cell type, and a nutrient, the source located outside of the container; and
means for introducing the reactant, cell type or nutrient to the predetermined reaction site; wherein
the means for introducing has a volume that is no more than 25 microliters.

51-52. (canceled)

53. A chemical, biological, or biochemical reactor chip apparatus, comprising:
a chemical, biological, or biochemical reactor chip comprising a first reactor comprising a container and a port for connecting the container to a source of a fluid to be introduced into the container, wherein
the container has a container volume of less than about 2 milliliters; and
one of:
(a) the port defines a boundary of the container; and
(b) a fluid channel connects the port and the container, and the fluid channel has a channel volume of less than 1 percent of the container volume.

54-61. (canceled)
